(19) United States
(12) Patent Application Publication
(10) Pub. No.: US 2002/0092025 A1
(43) Pub. Date: Jul. 11, 2002

(54) System with information output device and mobile communications terminal

(75) Inventor: Dieter Klumpp, Stuttgart (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/028,917

(22) Filed: Dec. 28, 2001

(30) Foreign Application Priority Data
Jan. 9, 2001 (DE) 101 00 648.9

(51) Int. Cl. H04N 7/16; H04H 1/00; H04H 7/00

(52) U.S. Cl. 725/62; 455/3.06; 455/3.01

(57) ABSTRACT

Information output devices for installation in public places normally used as service terminals or information terminals are known, such as for example automatic ticket issuing machines at railway stations and in tourist information terminals in town centres. A large-area screen and high-power loudspeakers effect a respective visual display and acoustic output of information previously received as video- or audio data via a data network to which the device is connected. The invention is based on the recognition that information received via a mobile communications terminal (20) can be directly transmitted to a fixed information output device (10) and output on said device with a high degree of quality. For this purpose the information output device (10) is extended by a receiving section (13) which wirelessly receives information signals containing video- and/or audio data from a mobile communications terminal (20) situated in the vicinity of the device (10) and which forwards these data to the video- and/or audio section for output via the screen (11) and/or loudspeaker (12) respectively.

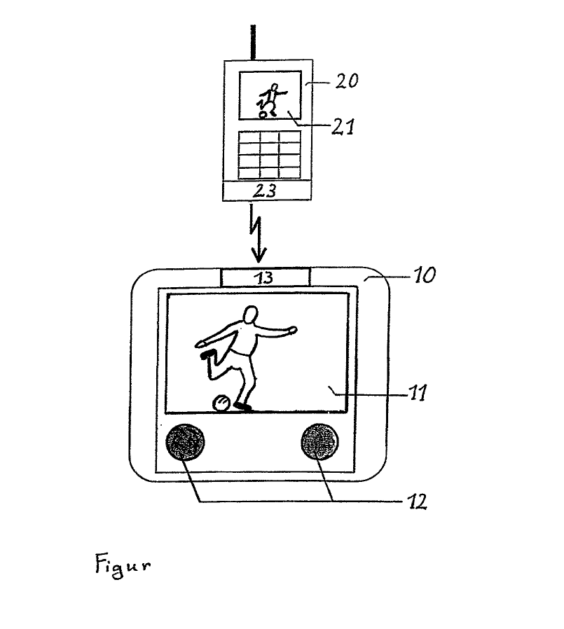

### BACKGROUND OF THE INVENTION

The invention is based on a priority application DE 101 00 648.9 which is hereby incorporated by reference. The invention relates to an information output device for installation in public places with a screen and/or with at least one loudspeaker which are controlled by a video- and/or audio section respectively, wherein the device comprises a receiving section which wirelessly receives information signals containing video- and/or audio data from a mobile communications terminal situated in the vicinity of the device and which forwards these data to the video- and/or audio section for output via the screen and/or loudspeaker respectively, a mobile communications terminal for transmitting information signals to an information output device for installation in public places with a screen and/or with at least one loudspeaker which are controlled by a video- and/or audio section respectively, wherein information signals contain video- and/or audio data, that the mobile communications terminal comprises transmitting means which wirelessly transmit the information signals containing the video- and/or audio data to the device, and that the device comprises a receiving section which wirelessly receives these information signals from the mobile communications terminal situated in the vicinity of the device and which forwards these data to the video- and/or audio section for output via the screen and/or loudspeaker respectively and a system, created therewith, with an information output device for installation in public places with a screen and/or with at least one loudspeaker, which are controlled by a video- and/or audio section respectively, and with a mobile communications terminal for the transmission of information signals to the information output device, wherein the information signals contain video- and/or audio data, that the mobile communications terminal comprises transmitting means which wirelessly transmit the information signals containing the video- and/or audio data to the device, and that the device comprises a receiving section which wirelessly receives these information signals from the mobile communications terminal situated in the vicinity of the device and which forwards these data to the video- and/or audio section for output via the screen and/or loudspeaker respectively.

### SUMMARY OF THE INVENTION

Information output devices for installation in public places, normally used as service terminals or information terminals, are known. Examples of such known devices are automatic ticket issuing machines at railway stations and airports, or tourist information terminals in town centres, at public events, in museums etc. These devices are equipped with a generally large-area screen on which information is visually displayed. This information is normally received as video data via a data network to which the device is connected. Or the information emanates entirely or partially from a data memory provided in the device. To enable the user to operate the device, a keyboard is usually provided. Devices also exist which additionally comprise one or two loudspeaker(s) via which audio data is output. Thus information output devices for installation in public places are known comprising a screen and/or at least one loudspeaker which are controlled by a video- and/or audio section respectively. These known devices thus have a multimedia capability but possess the disadvantage that only the information which is downloaded from the data network or which is already present in the data memory is output on the screen and/or via the loudspeakers. It is currently desirable to be able to receive data rapidly and easily at any location and to obtain an output of the information contained in said data in a powerful form, i.e. via a large screen and high-power loudspeakers.

The invention is based on the recognition that information received via a mobile communications terminal can be transmitted directly to a fixed information output device and output on said device with a high degree of quality. This links the possibility of mobile reception of information with high-quality and powerful video- and/or audio output.

In accordance with the invention, for this purpose the information output device referred to in the introduction is extended by a receiving section which wirelessly receives information signals containing video- and/or audio data from a mobile communications terminal situated in the vicinity of the device and which forwards these data to the video- and/or audio section for output via the screen and/or loudspeaker respectively.

This facilitates a direct wireless transmission of information signals, in particular those containing multimedia data, from the mobile communications terminal to the fixed device, in order to display the visual information on the large-area screen of said device and/or to output the acoustic information via the loudspeakers.

Also proposed is a mobile communications terminal suitable therefor and a system created from the device and the mobile communications terminal.

Particularly advantageous developments of the invention are described in the sub-claims.

Thus it is particularly advantageous if the receiving section is a radio signal receiving section for short-range transmission or an infrared signal receiving section. The implementation of the receiving section is thereby simplified, as for these types of short-range data transmission there exist numerous standards, such as for example Bluetooth or HAVI (Home Audio Video Interoperability), with appropriately designed standard components. Additionally, mobile communications terminals are increasingly being equipped with additional transmitter/receivers for radio- or infrared short-range transmission.

It is also particularly advantageous if the receiving section also wirelessly receives signalling data from the mobile communications terminal and forwards this data to the video- and/or audio section for the control of the output. This enables the device to be remote-controlled. The user of the mobile communications terminal can thus not only instigate the transmission of data to the device but also remote-control the device itself in order to change the display of video data (e.g. zoom function) or to influence the output of audio data (e.g. adjustment of the sound reproduction or speech selection).

It is also particularly advantageous if the device also comprises a transmitting section by which signalling data generated by the video and/or audio section are wirelessly transmitted to the mobile communications terminal. The device is thus in bidirectional communication with the mobile communications terminal. In this way for example, a menu selection given by the device can be transmitted to the mobile communications terminal. This facilitates, for example, interactive, user-driven remote control. In this context it is advantageous if the device also comprises a keyboard or speech input means for controlling the output.

In this way direct operation, preferably by voice control, can take place instead of or in addition to the foresaid remote control.

Particular advantages are also achieved if the video- and/or audio section contain(s) data conversion means which convert the received video- and/or audio data for output via the screen and loudspeaker respectively. These measures distinctly increase the acceptance of the device as the transmission and output of information is very substantially independent of the data format.

### BRIEF DESCRIPTION OF THE DRAWINGS

The invention and the advantages resulting therefrom will be described in more detail in the following in the form of an exemplary embodiment which is schematically illustrated in the attached drawing.

The FIGURE illustrates a device 10 which can be installed in fixed manner at any location, in particular in public places. The device 10 comprises a screen 11 consisting of a LCD (liquid crystal display) which is controlled by a video section (not shown). The device 10 also comprises two loudspeakers 12 which are controlled by an audio section (not shown). The device is thus suitable for multimedia video and audio reproduction. Normally, corresponding video- and/or audio data are downloaded from a network to which the device is connected, the device being operated by means of a keyboard. In accordance with the invention, the device also comprises a receiving section 13 which wirelessly receives information signals containing video- and/or audio data from a mobile communications terminal 20 situated in the vicinity of the device and which then forwards these data to the video- and/or audio section for output via the screen 11 and/or loudspeakers 12 respectively.

For the transmission of the data, the receiving section 13 shown in the FIGURE is designed as a radio receiver for short-range transmission according to the so-called Bluetooth standard. The device 10 can thus exchange both user data and control data with the mobile communications terminal 20. Video data in the MPEG format, picture data in the JPG format, text data in the RFT format, audio data in the WAV format or music data in the MP3 format are transmitted for example as user data. In the example illustrated in the FIGURE, the mobile communications terminal 20 receives video- and audio data from a mobile communications network operating in accordance with the UMTS standard (Universal Mobile Telecommunications System). The user of the mobile communications terminal 10 uses a service for the live transmission of sports events, here a football game. The representation on the generally extremely small display of the mobile communications terminal is qualitatively unsatisfactory. This also applies to the sound reproduction via the loudspeaker of the mobile communications terminal 20.

Therefore the user employs the device 10 and the provided output means thereof, i.e. the screen 11 and loudspeakers 12. For this purpose he proceeds into the vicinity of a device according to the invention and instigates a direct short-range transmission of the video- and audio data from his mobile communications terminal 20 to this device 10 via the corresponding transmitting/receiving means 23 and 13. By means of the device 10, which comprises a video- and audio section (not shown) connected to the receiver 13, a large-area and high-resolution video display then takes place on the screen 11 and a high-quality sound reproduction takes place via the loudspeakers 12. The device 10 also comprises data conversion means (not shown) which optionally convert the user data received by the receiving section 13 for subsequent representation and output.

With the aid of the proposed device it is provided that the content of user data received in mobile manner, and thus independently of location, is nevertheless reproduced with a high degree of quality, in particular with a high degree of visual resolution and acoustic quality. The device according to the invention increases and distinctly improves the representation of the content. The content in the form of picture, diagram, film, sound, speech, music etc. is thus reproduced in boosted form. The device could therefore also be referred to as “content booster”.

The invention is particularly suitable for integration in public information terminals and service terminals. Due to the provision of a receiving section for direct communication with mobile terminals, new, very attractive services are conceivable. For example, music data stored in the mobile terminal in MP3 format can be transmitted to the device and reproduced thereon in boosted form. The same applies to text data, in particular short messages, which have been received in mobile manner via SMS (short message service). This also applies to video data downloaded for example via mobile internet access or recorded via a digital camera. In particular with regard to the reproduction of music data, it should be stressed that the possibility exists of downloading the music data (for example in MP3 format) onto the mobile terminal using a copyright-compliant payment process, and of reproducing it via the more powerful loudspeakers of the device proposed here (content booster).

As shown by these examples, the use of the device according to the invention as content booster is very versatile.

Also conceivable is a bidirectional transmission of user- and signalling data between the mobile communications terminal and the device, thereby facilitating new interactive and user-driven services. For example, a user who often makes business trips can use his mobile communications terminal to download the relevant railway schedule or flight schedule with the required individual travel connections. As soon as he arrives at the railway station or airport, the user proceeds to a device in the form of an automatic ticket issuing machine and instigates a transmission of his travel data so that the machine can immediately issue the appropriate ticket. The same applies for example to hotel bookings. In the private sector, for example, bookings of vacation trips could be automated by the use of the described device. The use of the proposed device can be rendered cost-free or at least very cheap for the user if advertising windows are included on the screen of the device.

The described examples illustrate only part of the conceivable applications. The invention can be used in virtually all areas of life in which a high-quality and powerful representation of information is crucial for the acceptance of services.

1. An information output device for installation in public places with a screen and/or with at least one loudspeaker which are controlled by a video- and/or audio section respectively, wherein the device comprises a receiving section which wirelessly receives information signals containing video- and/or audio data from a mobile communications terminal situated in the vicinity of the device and which forwards these data to the video- and/or audio section for output via the screen and/or loudspeaker respectively.

2. A device according to claim 1, wherein the receiving section is a radio signal receiving section for short-range transmission or an infrared signal receiving section.

3. A device according to claim 1, wherein the receiving section also wirelessly receives signalling data from the mobile communications terminal and forwards said data to the video- and/or audio section for the control of the output.

4. A device according to claim 1, wherein the device also comprises a transmitting section which wirelessly transmits signalling data, generated by the video- and/or audio section, to the mobile communications terminal.

5. A device according to claim 1, wherein the device comprises a keyboard or speech input means for the control of the output.

6. A device according to claim 1, wherein the video- and/or audio section comprise(s) data conversion means which convert the received video- and/or audio data for output via the screen and/or the loudspeaker respectively.

7. A mobile communications terminal for transmitting information signals to an information output device for installation in public places with a screen and/or with at least one loudspeaker which are controlled by a video- and/or audio section respectively, wherein information signals contain video- and/or audio data, that the mobile communications terminal comprises transmitting means which wirelessly transmit the information signals containing the video- and/or audio data to the device, and that the device comprises a receiving section which wirelessly receives these information signals from the mobile communications terminal situated in the vicinity of the device and which forwards these data to the video- and/or audio section for output via the screen and/or loudspeaker respectively.

8. A system with an information output device for installation in public places with a screen and/or with at least one loudspeaker, which are controlled by a video- and/or audio section respectively, and with a mobile communications terminal for the transmission of information signals to the information output device, wherein the information signals contain video- and/or audio data, that the mobile communications terminal comprises transmitting means which wirelessly transmit the information signals containing the video- and/or audio data to the device, and that the device comprises a receiving section which wirelessly receives these information signals from the mobile communications terminal situated in the vicinity of the device and which forwards these data to the video- and/or audio section for output via the screen and/or loudspeaker respectively.
